(19) United States
(12) Patent Application Publication
(10) Pub. No.: US 2018/0112634 A1
(43) Pub. Date: Apr. 26, 2018

(54) Ejector Integrally Formed with an Intake Air Component and a Method to Manufacture

(71) Applicant: Ford Global Technologies, LLC, Dearborn, MI (US)

(72) Inventors: Steven James Hoffman, Ann Arbor, MI (US); John Emley, Canton, MI (US); Douglas Scott Sparks, West Bloomfield, MI (US); David S. Moyer, Sterling Heights, MI (US); Christopher Alan Myers, Holly, MI (US); Brandon William Bailey, Milford, MI (US); Roger Joseph Khami, Troy, MI (US)

(73) Assignee: Ford Global Technologies, LLC, Dearborn, MI (US)

(21) Appl. No.: 15/333,208

(22) Filed: Oct. 25, 2016

(51) Int. Cl. F02M 35/10; B29C 45/00; F02M 25/08; F02M 35/024

(52) U.S. Cl. CPC F02M 35/10229; B29C 45/006; F02M 25/089; F02M 35/10118; F02M 35/024; B29L 2031/7492; F02M 35/10157; F02M 35/10321; F02M 35/10347; F02M 35/1036; F02M 35/10144

(57) ABSTRACT

Vapors in the fuel tank of a vehicle are collected in a carbon canister. An ejector or aspirator is used to purge the carbon canister in a pressure-charged engine in which a positive pressure exists in the intake. A compact ejector includes a substantially planar flange and a venturi tube coupled to the flange with a central axis of the venturi tube substantially parallel to the flange. By manufacturing the ejector in two pieces, dimensions within the ejector: throat, converging section, and diverging section, is more accurate than prior art manufacturing techniques thereby providing better flow characteristics throughout the boost range. By forming one of the two pieces of the ejector integrally with the air intake component in which it is coupled, decreases part count and the number of manufacturing processes.

### FIELD OF INVENTION

The present disclosure relates to a vapor purge system for an internal combustion engine, particularly manufacture of an ejector for aiding purge during boosted operation.

### BACKGROUND

Vehicles are equipped with an evaporative emission control system that captures fuel vapors from the fuel tank of the vehicle and stores them in a canister in which charcoal particles or other suitable media are disposed. The fuel vapors are adsorbed onto the charcoal particles. To avoid overloading the canister such that the charcoal particles have no further capacity to absorb fuel vapors, the canister is purged regularly.

In a naturally-aspirated internal combustion engine, the pressure in the intake manifold is depressed. This vacuum is used to draw fresh air through the canister. The vapor-laden air is then inducted into the engine and combusted. A purge valve or port is provided that fluidly couples the canister with the intake of the engine when purging is desired.

In boosted engines, i.e., turbocharged, supercharged, or boosted by any suitable device, pressure in the engine's intake is often above atmospheric thereby reducing the available times for purging. To obtain a vacuum to drive purge flow, a tube with a throat (reduced diameter section) induces a higher flowrate which causes the vacuum. The component in which the throat is included is called an ejector or an aspirator.

An example of a prior art configuration in FIG. 1. An engine 10 has an air intake system including a manifold 12 and a throttle body 14. Throttle body 14 has an air passage 16 and a throttle valve 18 to control the quantity of air flowing into manifold 12. Throttle body 14 has an inlet 20 fluidly connected to an outlet 22 of a turbocharger assembly 24.

Turbocharger assembly 24 includes a compressor 26 and a turbine 28. Compressor 26 and turbine 28 are both mounted upon a common shaft 30. Exhaust gases are directed through a duct 32 to turbine 28 and discharged through an outlet tube 34.

Compressor 26 receives air from an inlet duct 36. Air is pressurized by compressor 26 and discharged into outlet 22 and then into throttle body 14 or charge air cooler into manifold 12 and then into engine 10.

Modern engines are equipped with vapor emission control systems which include a fuel vapor storage canister 38. Vapor storage canister 38 has a quantity of activated charcoal particles 40 or other suitable adsorbent material. Activated charcoal absorbs fuel vapor and stores them. Charcoal particles 40 are secured between a lower screen 42 and an upper screen 44. Fuel vapors and air are routed to the interior of canister 38.

Charcoal 40 has a finite storage capacity of fuel vapor. Therefore, the canister is purged periodically to remove fuel vapor from the charcoal by drawing air from the atmosphere into the canister and through the activated charcoal bed. Atmospheric air flows through picking up molecules of fuel vapor in an adsorption process. The fuel laden air is drawing into combustion chambers of engine 10 and burned. An air inlet 46 is provided to allow purge air to engine canister 38. Air from inlet 46 passes downward through a duct 48 to a space 50 beneath the screen 42 and above the bottom of canister 38.

Canister 38 has an outlet opening 52 to allow purge air and fuel vapors to be discharged from canister 38. Normally, purge air and fuel vapor is desorbed from the charcoal through a conduit 54 to either of conduits 56 or 58; alternatively, the conduit can be coupled to the intake manifold. When engine 10 is idling, throttle valve 18 assumes a position 18′ and the interior of throttle body 14 downstream of throttle valve 18 is at a vacuum. During this period, purge air is drawn from conduit 56 through an orifice 60. Excessive purge can interfere with engine performance. A fuel vapor management valve 62 controls air-fuel vapor purge based on engine operating conditions into intake manifold 12.

When engine 10 is operating at part throttle, i.e. with throttle valve 18 between the idle position and wide open throttle (position shown as element 18 in FIG. 1). The portion of throttle body 14 upstream of throttle valve 18 is exposed to manifold vacuum pressure. This vacuum includes air flow through conduit 58, check valve 64, an orifice 66, and port 68 into throttle body 14. Purge flow is influenced by the relative position of throttle valve 18 to port 68 and by the size of the orifice. Orifice 66 limits the purge air flow into engine 10 as appropriate for smooth operation.

When engine 10 is operating under boost conditions, compressor 26 generates a greater pressure at outlet 22 of turbocharger 24 than at inlet 36. Under these conditions, compressor 26 generates a positive pressure in throttle body 14 and in manifold 12. Check valves 62, 64 prevent air flow from throttle body 14. The positive pressure at outlet 22 causes air to flow through a conduit 70 to an inlet end portion 72 of an ejector 74. Ejector 74 includes a housing defining inlet end portion 72, outlet end portion 66 and a reduced dimension passage 78 (throat) there between. Air passes from inlet 72 through throat 78 to an outlet 76 and then through conduit 80 to inlet 36 of compressor 26. Flow of air through throat 78 reduces pressure as is well known by one skilled in the art.

Ejector 74 also includes a purge air passage 82 which opens into passage 78. Conduit 54 is connected to the purge air passage of ejector 74. A check valve 84 allows the flow of air and vapors from conduit 54 into passage 82 and then into passage 78. Finally, purge air and vapor pass through conduit 70 into throttle body 14 and then into engine 10. During non-boost operation of engine 10, check valve 84 prevents air flow from ejector 74 back to canister 38.

The above-described emissions control operates effectively to route purged vapors to engine 10 and treatment by a catalytic converter (not shown). However, under some conditions, it is undesirable to purge canister 38. For example, when the catalytic converter is too cool to effectively process exhaust gases, provision is made to prevent canister purging. A control valve 86 is provided downstream of outlet opening 52 from canister 38. Valve 86 has an outlet port 88 formed by a valve seat 90. A movable valving member such as a diaphragm 92 is normally positioned by a spring 94 against seat 90 so that air cannot flow through valve 86. This is the condition of the valve when no purge is desired as mentioned above.

When air flow through valve 86 is desired, a vacuum pressure is introduced into valve 86 above the diaphragm 92 which unblocks port 88. Vacuum is directed to valve 86 through a conduit 96 which is connected to a port of a solenoid controlled on-off valve 98. Another port of valve 108 is connected to a conduit 100. In turn, the conduit is connected to a conduit 104. An electric solenoid valve 108 is connected to a conduit 100. In turn, conduit 100 is connected to check valve 102 which is connected to a conduit 104. When open, vacuum is communicated to the space above diaphragm 92 thus allowing purging. When closed, no vacuum is routed to the space above diaphragm 92 thus allowing purging. When closed, no vacuum is routed to the space above the diaphragm and port 88 is blocked thus preventing purging of canister 38. Solenoid valve 108 is commanded to energize by an engine electronic control unit 110 (ECU).

The componentry shown in FIG. 1 is provided merely as background to the present disclosure and is not intended to be limiting in any way. The components are known to be coupled in alternative ways to that shown in FIG. 1.

Ejector 74 of FIG. 1 suffers from multiple deficiencies. It is a stand-alone part that must be separately packaged, protected from damage, and supported. It is known to mount an ejector on an engine intake component, such as shown in FIG. 4. Referring first to FIG. 2, an ejector 120 is shown that has a flange 122 through which tubes 124 and 126 extend. Ejector 120 is shown in cross section in FIG. 3. Disposed in tube 124 is an insert 130 with a reduced cross section. Insert 130 has a throat 132 with a small cross section. The speed at which gases move through throat 132 is much greater than the speed of the flow at an inlet of tube 124. Downstream of insert 130 is a straight section 136. It would be preferable to have this be a diverging tube. Prior art manufacturing methods led to tube 136 being straight. Tube 134 couples to tube 124 at the location of throat 132 via a tee tube 134 to thereby induce flow through 126. In the fabrication of ejector 120, the inside diameter of tube 134 is formed through an orifice proximate a plug 128. After fabrication, tee tube 134 is sealed via plug 128. Ejector 120 is shown mounted to an air box 150 in FIG. 4.

The ejector system shown in FIG. 4 presents some deficiencies. Referring to FIG. 4, the depth that the ejector extends into air box 150 is shown by numeral 140 and the width of ejector 120 within air box 150 is shown by numeral 142 in FIG. 3. This presents considerable encroachment on the interior of air box 150. Air boxes have unique designs depending on the engine, the vehicle, and other package considerations such as other accessories. Although it would be desirable for a vehicle manufacturer to have three or four standard air boxes, in reality, there is little crossover among different vehicles. It is likely that many unique ejectors would be required to mate to a variety of air boxes. The ejector of FIGS. 2-4 has three elements: the main body of ejector 120, a cap 144, and insert 130. Insert 130 is sometimes molded separately to avoid a molding process in which a thin pin is used to form the opening. A tube 136 downstream of insert 130 is straight because a pin is pulled to form tube 136. This is not the preferred shape, simply what is available based on the manufacturing process. Disadvantages in the prior art include: the requirement of molding a separate piece for the insert and a plug; obtaining an ejector with less than desired flow characteristics (due to having straight section downstream of the throat); and the resulting ejector is bulkier than desired.

An ejector that is compact and easy to manufacture while maintaining tight tolerances, particularly in the throat area, is desired.

### SUMMARY

To overcome at least one problem in the prior art, an ejector system for a boosted engine includes: a first section of an intake air component having a first ejector portion unitarily formed and a second ejector portion affixed to the first ejector portion. The first and second ejector portions comprise a venturi tube having a converging section, a throat, and a diverging section. The ejector further includes a first tube and a second tube. The second tube fluidly couples to the venturi tube proximate the throat.

The system further includes a second section of the intake air component affixed to the first section of the intake air component.

In some embodiments, the first and second ejector portions each comprise about one-half of the venturi tube.

The first and second tubes are integrally formed with the first ejector portion. The second tube fluidly couples with an upstream end of the converging section.

The first and second tubes are integrally formed with the second ejector portion; and

the second tube fluidly couples with an upstream end of the converging section.

In some embodiments, the intake air component is an air filter box. In other embodiments, the intake air component is an intake air duct.

The center of the venturi tube is substantially parallel to a wall of the intake air component to which it is coupled.

Also disclosed is an ejector system that has a first section of an intake air component having a first ejector portion unitarily formed therewith, a second section of the intake air component affixed to the first section of the intake air component, and a second ejector portion affixed to the first ejector portion. The first and second ejector portions form a venturi tube having a diverging section, a throat section, and a converging section. The first and second ejector portions each include portions of the diverging, throat, and converging sections.

The second section of the intake air component is affixed after the second ejector portion is affixed to the first ejector portion.

The first and second intake air components are affixed by one of: sonic welding, vibration welding, induction welding, laser welding, snap fitting, ultrasonic welding, a hot plate, and infrared welding, and thermal welding.

The ejector further includes: a first tube fluidly coupled to the converging section of the venturi tube and a second tube fluidly coupled proximate the throat section of the venturi tube. The first and second tubes are integrally formed with the first section of the air intake component.

In some embodiments, the air intake component is an intake air duct and the first section of the intake air duct and the second section of the intake air duct couple axially.

In some embodiments, a centerline of the first tube forms an acute angle with a surface of the air intake component proximate the first tube.

Also disclosed is a method fabricate an ejector system that includes: injection molding a first portion of the air intake component, the air intake component including a first venturi tube portion, injection molding a second venturi tube portion, and affixing the first venturi tube portion to the second venturi tube portion.

The first and second venturi tube portions are part of the ejector. Considering the venturi upstream to downstream, the venturi tube has a converging section, a throat section, and a diverging section. The ejector has first and second tubes. In some embodiments, the first and second tubes are integrally formed with the first venturi tube portion. In other embodiments, the first and second tubes are integrally formed with the second venturi tube portion.

The method further includes injection molding a second portion of the air intake component and affixing the second portion of the air intake component to the first portion of the air intake component. The affixing of the second portion of the air intake component to the first portion of the air intake component occurs after the first venturi tube portion is affixed to the second venturi tube portion.

The affixment of the first venturi tube portion to the second venturi tube portion is by one of: sonic welding, vibration welding, induction welding, laser welding, ultrasonic welding, hot plate, and infrared welding, thermal welding, and snap fitting.

According to embodiments of the disclosure, because a portion of the ejector is integrally molded with a portion of the air intake component, the following advantages are realized: reduced part count, decrease in the number of operations, a compact ejector with a low profile, reduced system weight, less material cost, improved dimensional accuracy (particularly in the throat region), and improved flow characteristics compared to some prior art ejectors.

### BRIEF DESCRIPTION OF THE DRAWINGS

FIG. 1 is an illustration of a canister purge system which includes an ejector according to the prior art;

FIG. 2 is a prior art ejector;

FIG. 3 is the ejector of FIG. 2 in cross section;

FIG. 4 is the ejector of FIG. 2 shown installed in an air box;

FIG. 5 is an illustration of an ejector prior to assembly in an intake air duct;

FIG. 6 is a cross-sectional illustration of the two-piece ejector of FIG. 5;

FIGS. 7-9 are illustrations of a first embodiment of a portion of an air intake duct with a portion of an ejector unitarily molded with the intake duct;

FIGS. 10-12 are illustrations of a second embodiment of a portion of an air intake duct with a portion of an ejector unitarily molded with the intake duct;

FIGS. 13-15 are illustrations of a third embodiment of a portion of an air intake duct with a portion of an ejector unitarily molded with the intake duct;

FIGS. 16-18 are illustrations of an air filter box with a portion of an ejector unitarily molded with the air filter box;

FIGS. 19 and 20 show snap-fit connections for coupling first and second ejector portions.

FIGS. 21 and 22 are flowcharts indicating processes by which the air intake component and an ejector are fabricated.

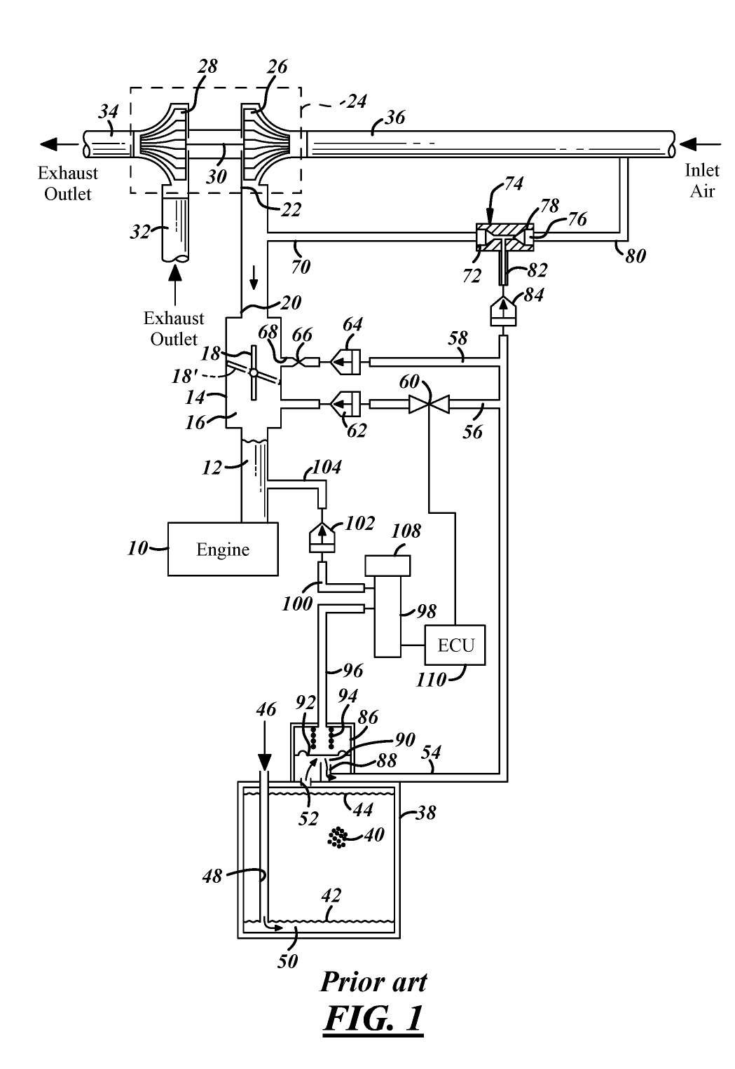

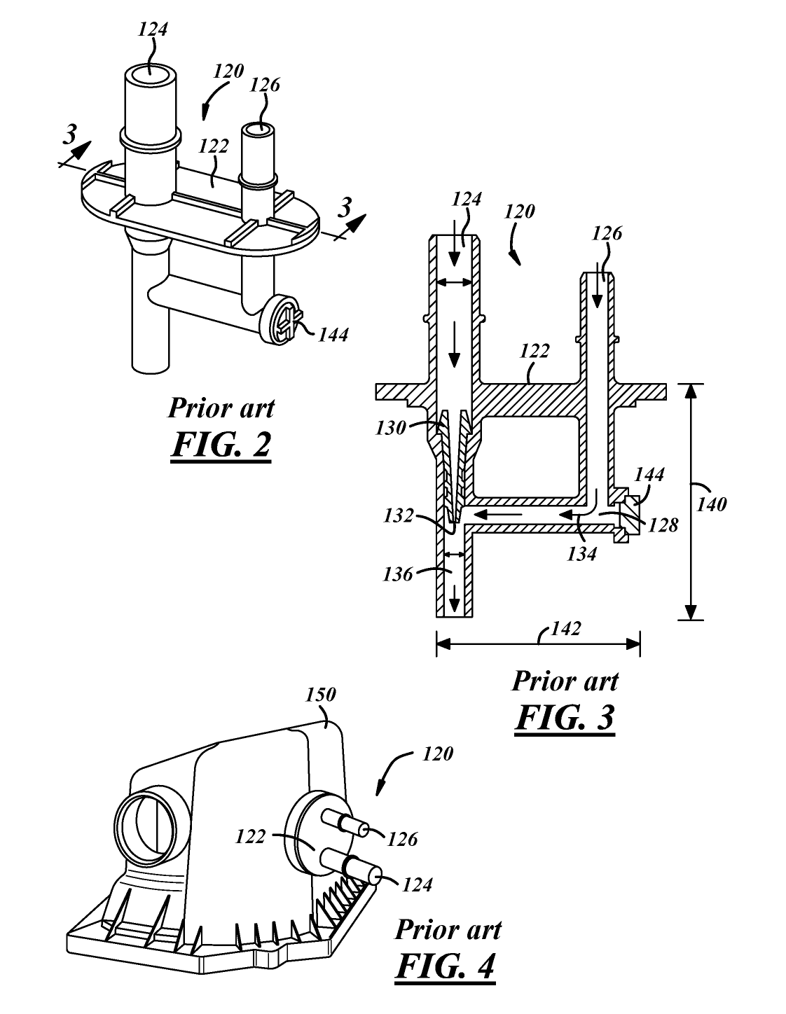

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

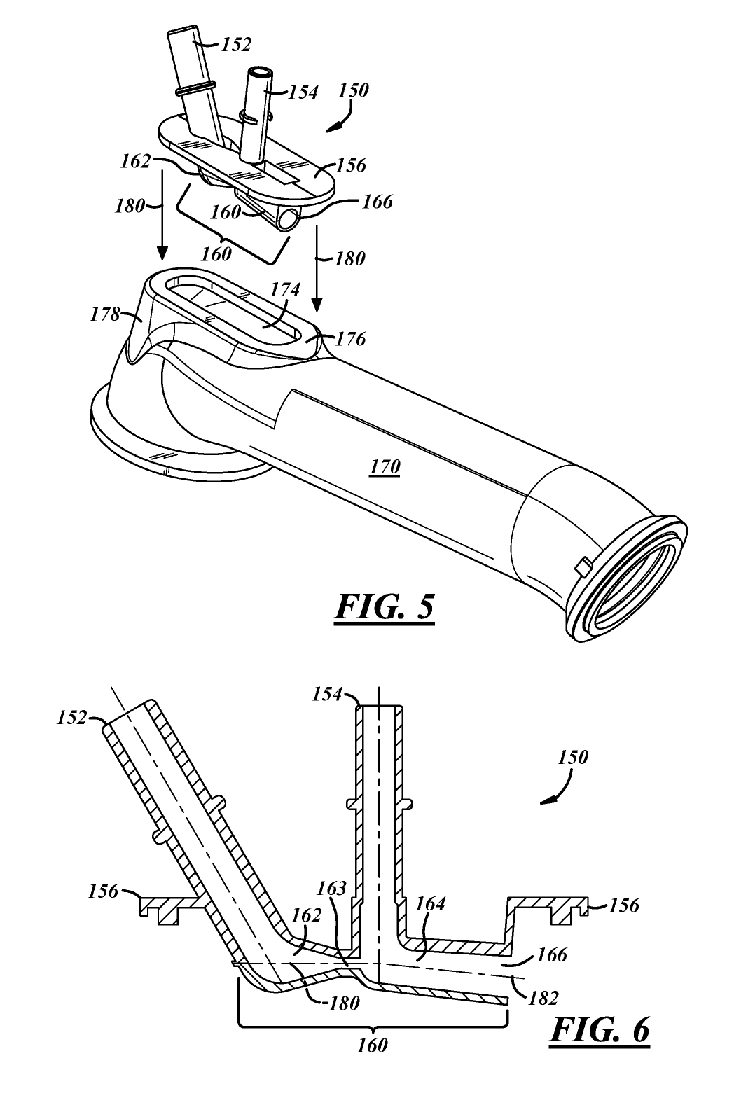

An ejector 150 disclosed in commonly assigned application U.S. Ser. No. 15/225,920 is shown in cross section in FIG. 5. Ejector 150 has a first tube 152 that can be coupled to an intake duct (not shown) to bring in fresh air and a second tube 154 that can be coupled to a carbon canister (not shown) in which fuel vapors are stored. Tubes 152 and 154 extend out from a flange 156. A venturi tube 160 of ejector 150 has a converging section 162, a throat (not shown) and a diverging section 164 that has an exit 166. Ejector 150 is made up of two portions, an upper portion that includes tubes 152 and 154, flange 156, and an upper portion of venturi tube 160; and a lower portion that includes a lower portion of venturi tube 160. Ejector 150 is shown above an air duct 170 prior to assembly. Air duct 170 has a protuberance 178 that accommodates forming a flat surface 176 (flange) onto which flange 156 of ejector 150 mounts and couples. Surface 176 surrounds an opening 174 into which venturi tube 160 is placed. Opening 174 is large enough to allow venturi tube 160 to go into opening 174 straight on, as shown by arrows 180. Ejector 150 is affixed to air duct 170 by friction welding or any other suitable process.

Ejector 150 of FIG. 5 is shown in cross section in FIG. 6. Venturi tube 160 includes converging section 162, a throat 163, and diverging section 164 that has an exit 166. Ejector 150 is made of two pieces that are coupled together via friction welding or any suitable technique. The first piece includes tubes 152 and 154, flange 156, and the upper half of venturi tube 160, i.e., above lines 180 and 182. The second piece of ejector 150 includes the portion of venturi tube 160 below lines 180 and 182.

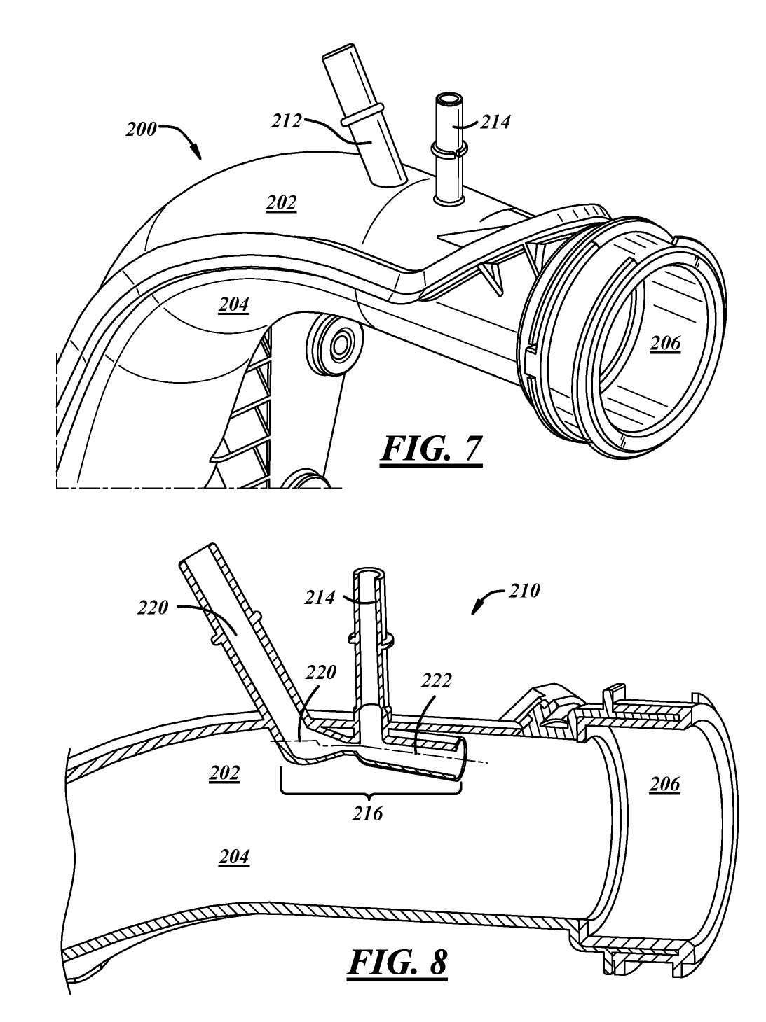

In FIG. 7, a portion of an air duct 200 is made up of two portions 202 and 204 that couples along axial connections. Duct 200 has a circular inlet 206. An ejector is integrated into air duct 200, with tubes 212 and 214 extending outwardly from a surface of duct 200. A cross section of air duct 200 is shown in FIG. 8. Ejector 210 is shown with tubes 212 and 214 extending out of a first portion 202 of the air intake duct. Tube 212, tube 214, and the portion of a venturi tube 216 that is above lines 220 and 222 (centerlines through venturi tube 216) are formed integrally with first portion. 202. A portion of venture tube 216 that is below lines 220 and 222 is formed separately and then attached afterward. Another view of ejector 210 and first portion 202 is shown. Venturi tube 216 has an upper portion 224, that along with tubes 212 and 214 are integrally formed with first portion 202. A lower portion 226 of venturi tube 216 is formed separately. In FIG. 10, lower portion 226 of the venturi tube of ejector 210 is shown before affixing it to upper portion 224 of the venturi tube. Lower portion 226 is coupled to upper portion 224 via friction welding or any other suitable method.

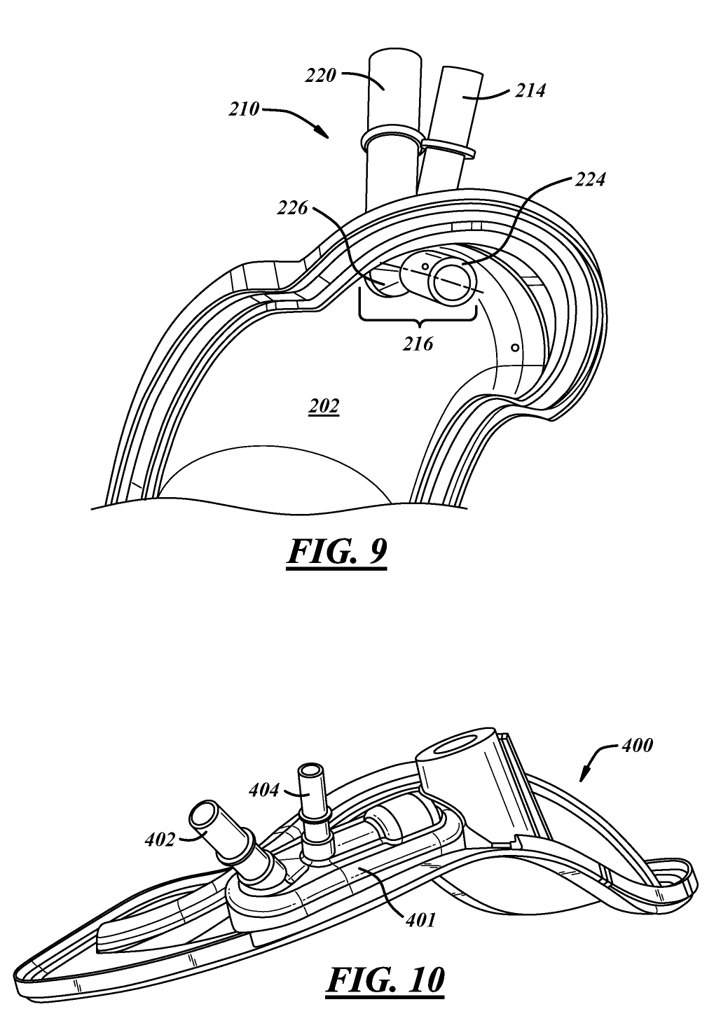

Referring back to FIG. 9, it can be seen that it is possible to access the underside (inner surface) of first portion 202 so that lower portion 226 of venturi tube 216 can be affixed to upper portion 224 of venturi tube 212. The example of an air duct that is fully formed, such as shown in FIG. 5 does not present the access to affix a portion of the venturi tube to the other portion of the ejector. Thus, in FIG. 5, flange 156 of ejector 150 and protuberance 178 and flange 176 are provided on air duct 170. The embodiment in FIGS. 7-10 presents a number of advantages including fewer separate parts that are assembled and obviation of two flanges (on air duct and on the ejector), thereby providing lower weight and lower material costs. Of course, the embodiment in FIGS. 7-10 is facilitated by the two-piece intake duct that is separated axially.

In FIGS. 7-9, the upper portion of the ejector is integral with a wall of a portion on the intake duct. In an alternative embodiment, a section 400 of an air duct has a protuberance 401 in which an upper portion of the ejector is molded. First tube 402 and second tube 404 of the ejector extend out of protuberance 401. In FIG. 11, an underside of section 400 of the air duct shows the indentations that form a portion of a converging section 410, a throat 408, and a diverging section 410 of the ejector. The outlet opening 405 of tube 404 is adjacent to throat 408. Another portion 412 of the ejector that forms a venturi has a converging section 420, a throat 418, and a diverging section 416. Portion 412 is affixed to the portion of the ejector that is integral with portion 400 of the air duct. Converging sections 410 and 420, throat sections 408 and 418, and diverging sections 406 and 406 are mated together. These can be affixed via friction welding, an adhesive, a snap fit connection, or any suitable coupling technique.

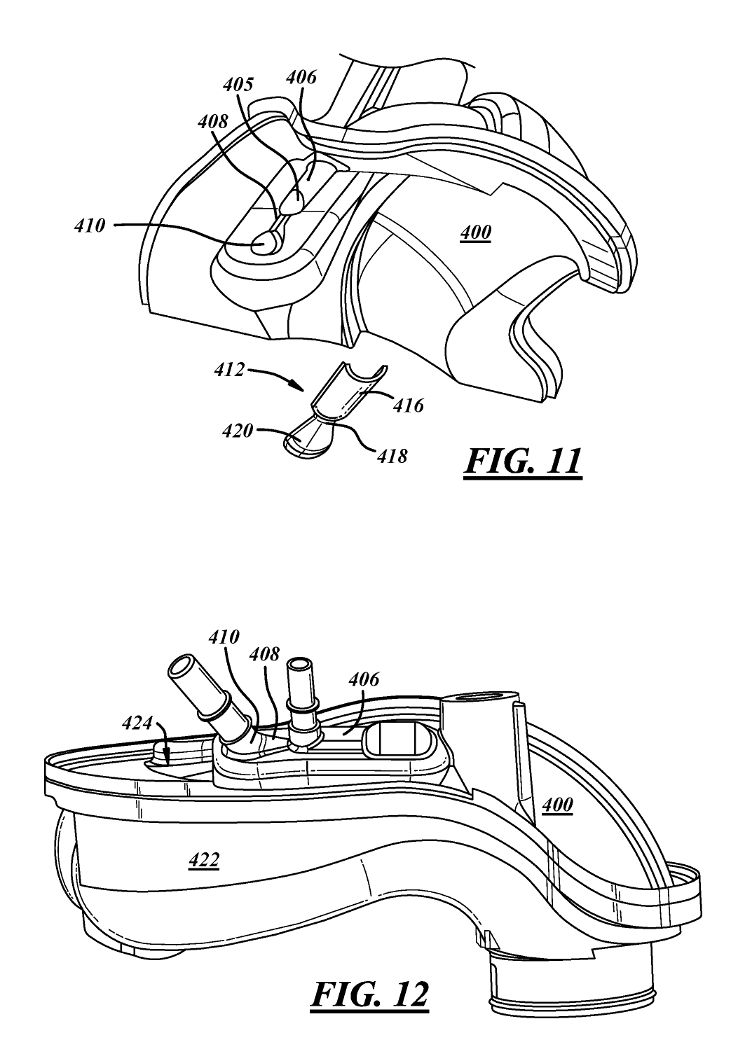

After the ejector is made whole by coupling 412 to the ejector portion in portion 400, a second section 422 of the air duct is coupled to section 400 of the air duct, as shown assembled in FIG. 12. In the embodiment shown in FIG. 12, first tube 410 forms an acute angle 424 with the surface of first section 400 of the air duct.

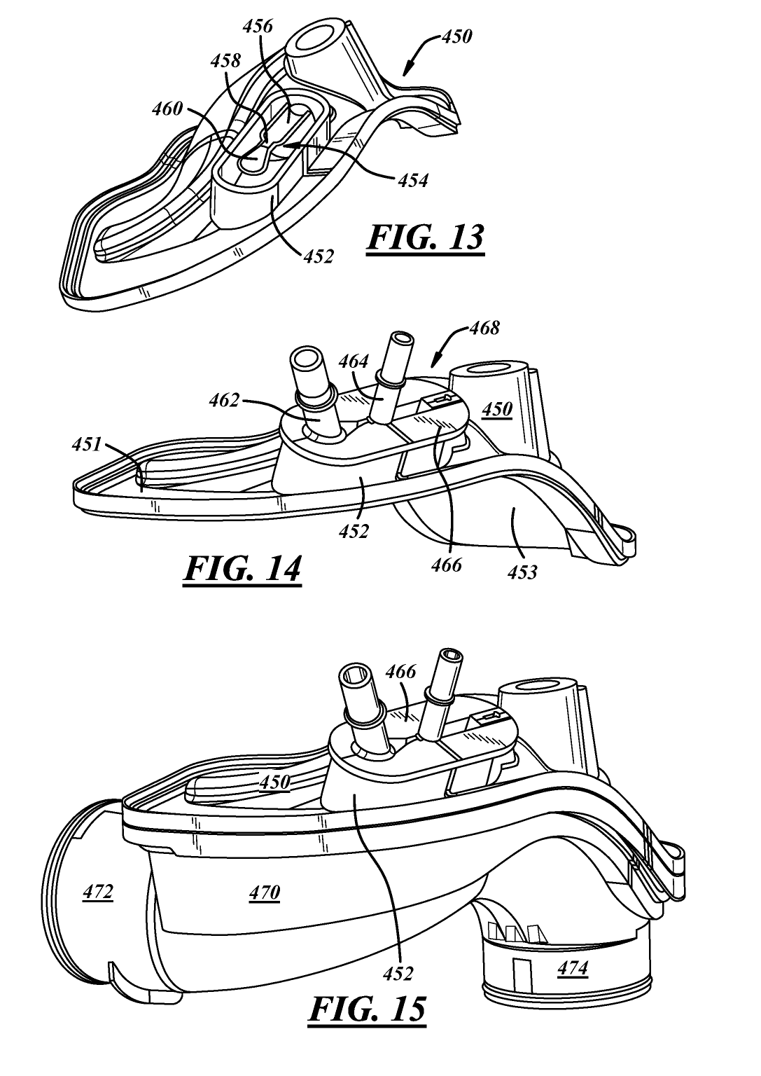

In an alternative embodiment shown in FIGS. 13-15, a lower portion 454 of an ejector is integrally formed with a first section 450 of an air duct (FIG. 13). Lower portion 454 has a converging section 460, a throat 458, and a diverging section 456. First section 450 has a built up wall 452. In FIG. 14, an upper portion 468 of the ejector is coupled to first section 450 of the air duct. Upper part 468 has a flange 466 that is affixed to an upper surface of wall 452. An inner surface 453 of first portion 450 and an outer surface 451 of first portion 450 are both visible in FIG. 14.

In FIG. 15, a second section 470 of the air duct is shown coupled to first section 450. Second section 470 has an inlet 472 and an outlet 474.

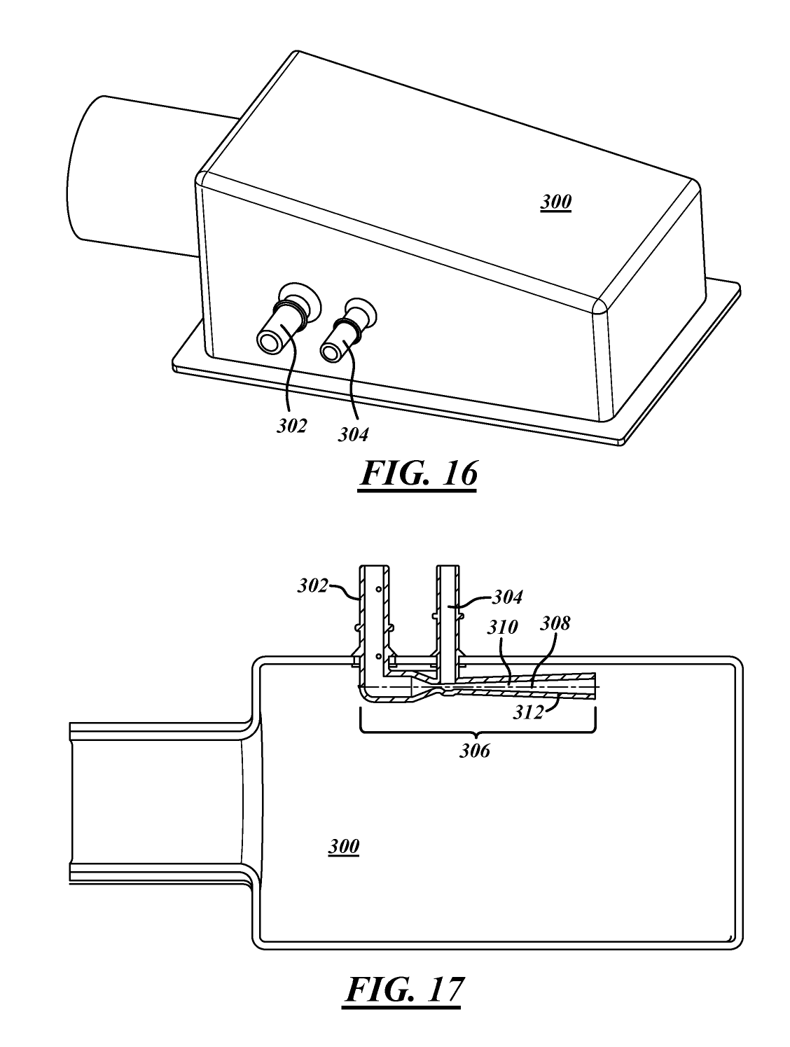

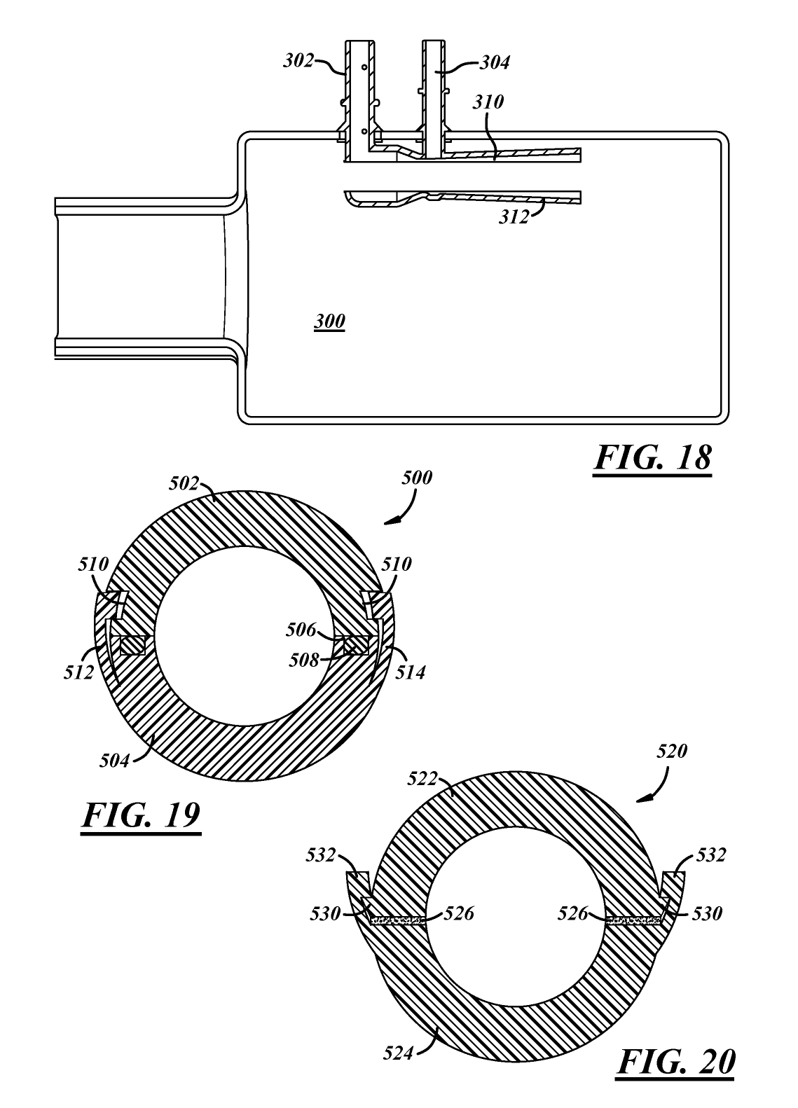

In FIG. 16 ducts 302 and 304 of an ejector are shown extending outwardly from an air filter box 300. A cross section through box 300 and the ejector is shown in FIG. 17. Tubes 302 and 304 as well as an upper portion 310 of venturi tube 306 are integrally formed with box 300. A lower portion 312 of the ejector, i.e., the portion that is below line 312, which is substantially a centerline of venturi tube 306, is formed separately by injection molding, or any suitable process. In FIG. 18, the ejector of FIG. 17 is shown prior to affixing lower portion 312 to upper portion 310.

The two pieces of the ejector, one of which is integral with the air intake component, may be coupled by welding. According to an alternative embodiment, the ejector is coupled via a snap fit. In a cross-sectional view in FIG. 19, an upper piece 502 and a lower piece 504 of a portion of an ejector 500 is shown. Lower piece 504 is provided with a groove 506 in a face of lower piece 504 that interfaces with lower piece 502. An O-ring 508 is placed into groove 506. Upper piece 502 is provided with a recess 510 along an outer surface. Recess 510 does not extend all the way to the interface with lower piece 502. A lip 514 extends outwardly. Lower piece 512 is molded with a flexible finger 510 that engages with lip 514.

In another embodiment in FIG. 20, a cross section of a portion of an ejector 520 has an upper piece 522 and a lower piece 524. Upper piece 520 has a wedge 530 that extends outwardly from the surface. Lower piece 524 has a flexible finger 532 that engages with wedge 530. In the embodiment in FIG. 20, an adhesive 526 has been applied to the interface surface of upper part 522 and/or the interface surface of lower part 524. In FIGS. 19 and 20, the flexible finger is on the lower part. However, this is simply a non-limiting example. Variations of these examples are also within the scope of the disclosure.

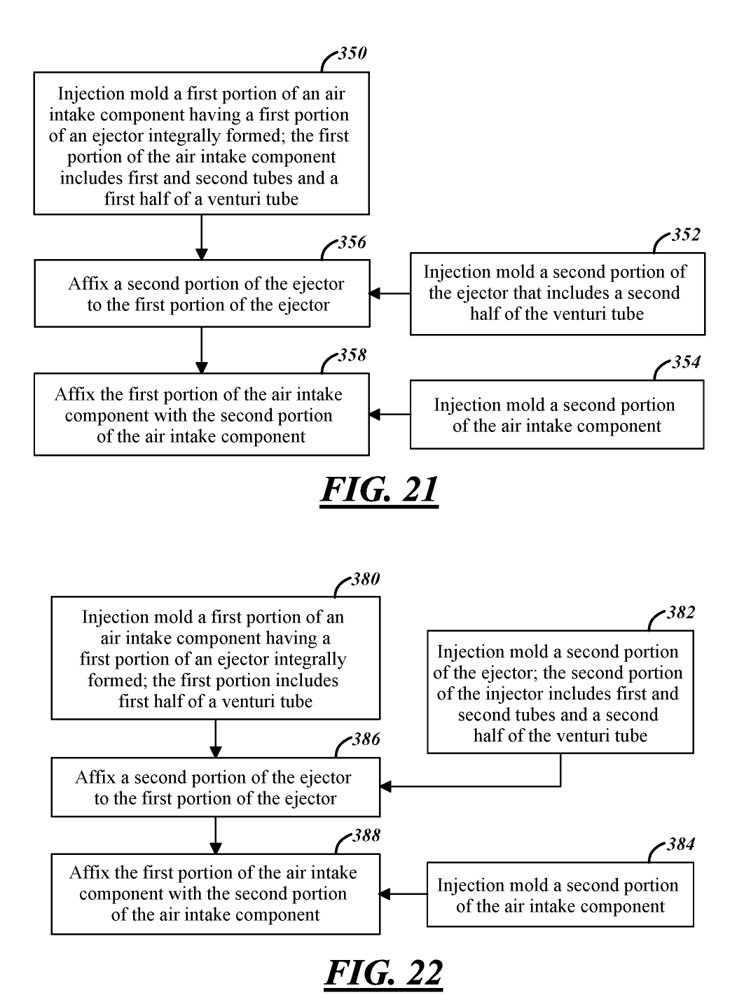

According to embodiments of the disclosure, an intake component with an ejector affixed is simplified over prior-art ejectors. Referring to FIG. 21, an overview of the process is shown starting in block 350 when a first portion of an air intake component is formed, by injection molding in a non-limiting example. A first portion of the intake component includes first and second tubes and a first half of a venturi tube of an injector that is integrally molded. In block 352, a second portion of the ejector is formed, for example by injection molding. The second portion of the ejector includes a second half of the venturi tube. In block 354, a second portion of the air intake component is injection molded, or formed by any suitable process. In block 356, the second portion of the ejector is coupled to the first portion of the ejector. This can be via friction welding, snap fitting, or any suitable process. In block 358, the second portion of the air intake component is affixed to the first portion of the air intake component.

Referring now to FIG. 22, in block 350 a first portion of an air intake component is injection molded; the first portion includes a first half of a venturi tube of the ejector. In block 352, a second portion of the ejector is injection molded. The second portion of the ejector, in this example, includes first and second tubes and a second half of the venturi tube of the ejector. In block 354, the second portion of the air intake component is injection molded. In block 356, the second portion of the ejector is affixed to the first portion of the ejector. In block 358, the first and second portions of the intake air component. The air intake component can be an air duct, an air filter box, or any suitable air intake component.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, efficiency, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

We claim:

1. An ejector system for a boosted internal combustion engine, comprising:
a first section of an intake air component having a first ejector portion unitarily formed; and
a second ejector portion affixed to the first ejector portion wherein:
the first and second ejector portions comprise a venturi tube having a converging section, a throat, and a diverging section;
the ejector further comprises a first tube and a second tube; and
the second tube fluidly couples to the venturi tube proximate the throat.

2. The ejector system of claim 2, further comprising:
a second section of the intake air component affixed to the first section of the intake air component.

3. The ejector system of claim 1 wherein the first and second ejector portions each comprise about one-half of the venturi tube.

4. The ejector system of claim 1 wherein:
the first and second tubes are integrally formed with the first ejector portion; and
the second tube fluidly couples with an upstream end of the converging section.

5. The ejector system of claim 1 wherein the intake air component an air filter box.

6. The ejector system of claim 1 wherein the intake air component is an intake air duct.

7. The ejector system of claim 1 wherein the center of the venturi tube is substantially parallel to a wall of the intake air component to which it is coupled.

8. An ejector system for a boosted internal combustion engine, comprising:
a first section of an intake air component comprising a first ejector portion unitarily formed therewith;
a second section of the intake air component affixed to the first section of the intake air component; and
a second ejector portion affixed to the first ejector portion wherein:
the first and second ejector portions comprise a venturi tube having a diverging section, a throat section, and a converging section;
the first and second ejector portions each comprise portions of the diverging, throat, and converging sections.

9. The ejector system of claim 8 wherein the second section of the intake air component is affixed after the second ejector portion is affixed to the first ejector portion.

10. The ejector system of claim 8 wherein first and second intake air components are affixed by one of: sonic welding, vibration welding, induction welding, laser welding, snap fitting, ultrasonic welding, a hot plate, and infrared welding, and thermal welding.

11. The ejector system of claim 8, further comprising:
a first tube fluidly coupled to the converging section of the venturi tube; and
a second tube fluidly coupled proximate the throat section of the venturi tube wherein the first and second tubes are integrally formed with the first section of the air intake component.

12. The ejector system of claim 8 wherein:
the air intake component is an intake air duct; and
the first section of the intake air duct and the second section of the intake air duct couple axially.

13. The ejector system of claim 8, wherein first and second ejector portions are affixed by one of: sonic welding, vibration welding, induction welding, laser welding, snap fitting, ultrasonic welding, a hot plate, and infrared welding, and thermal welding.

14. The ejector system of claim 11, wherein a centerline of the first tube forms an acute angle with a surface of the air intake component proximate the first tube.

15. A method to fabricate an air intake component with an ejector, comprising:
injection molding a first portion of the air intake component, the air intake component comprising a first venturi tube portion;
injection molding a second venturi tube portion; and
affixing the first venturi tube portion to the second venturi tube portion.

16. The method of claim 15 wherein:
the first and second venturi tube portions are part of the ejector;
from upstream to downstream, the venturi tube comprises a converging section, a throat section, and a diverging section;
the ejector further comprises first and second tubes that are integrally formed with the first venturi tube portion;
the first tube fluidly couples to an upstream end of the converging section; and
the second tube fluidly couples proximate the throat section.

17. The method of claim 15 wherein:
the first and second venturi tube portions are part of the ejector;
from upstream to downstream, the venturi tube comprises a converging section, a throat section, and a diverging section;
the ejector further comprises first and second tubes that are integrally formed with the second venturi tube portion;
the first tube fluidly couples to an upstream end of the converging section; and
the second tube fluidly couples proximate the throat section.

18. The method of claim 15, further comprising:
injection molding a second portion of the air intake component; and
affixing the second portion of the air intake component to the first portion of the air intake component wherein the affixing of the second portion of the air intake component to the first portion of the air intake component occurs after the first venturi tube portion is affixed to the second venturi tube portion.

19. The method of claim 15 wherein the affixment of the first venturi tube portion to the second venturi tube portion is by one of: sonic welding, vibration welding, induction welding, laser welding, ultrasonic welding, hot plate, and infrared welding, thermal welding, and snap fitting.

20. The method of claim 15 wherein the air intake component is one of an intake air component and an air filter box.
